(19) United States
(12) Patent Application Publication
(10) Pub. No.: US 2012/0234864 A1
(43) Pub. Date: Sep. 20, 2012

(54) LIQUID CONTAINER

(75) Inventor: Sheng-Yu Liu, Taipei City (TW)

(73) Assignee: FREE-FREE INDUSTRIAL CORP., Taipei City (TW)

(21) Appl. No.: 13/049,430

(22) Filed: Mar. 16, 2011

(51) Int. Cl. B67D 7/06

(52) U.S. Cl. 222/185.1

(57) ABSTRACT

A liquid container includes a housing having a bottom wall, an upright surrounding wall that has a top portion extending upwardly from a peripheral edge of the bottom wall, and a receiving space defined by the bottom wall and the top portion of the upright surrounding wall. The upright surrounding wall has front, rear, left and right sides. The front side has a liquid outlet opening communicated with the receiving space. The bottom wall is inclined downwardly from the rear side to the front side and has a lowest part adjacent to the front side.

### BACKGROUND OF THE INVENTION

1. Field of the Invention

The invention relates to a liquid container.

2. Description of the Related At

A liquid container with a relatively small volume is usually in the form of a cup or a bottle that is convenient to hold by hand, so that the liquid received therein can be easily poured out or sucked out with a straw. Another liquid container with a relatively large volume is usually in the form of a barrel that has a heavy weight and a liquid received therein is difficult to pour out. Thus, a conventional liquid barrel usually includes a tap that allows a liquid received therein to flow out therethrough. However, since the liquid barrel usually has a horizontally disposed flat bottom wall, the liquid cannot completely flow out when the liquid level becomes relatively low. Thus, the liquid barrel should be tilted toward the side of the tap. Therefore, the conventional liquid barrel is inconvenient to use in such circumstances.

### SUMMARY OF THE INVENTION

The object of the present invention is to provide a liquid container that allows the liquid to completely flow out without tilting the liquid container.

The liquid container according to the present invention comprises a housing that includes a bottom wall, an upright surrounding wall that has a top portion extending upwardly from a peripheral edge of the bottom wall, and a receiving space defined by the bottom wall and the top portion of the upright surrounding wall. The upright surrounding wall has front, rear, left and right sides. The front side has a liquid outlet opening communicated with the receiving space. The bottom wall is inclined downwardly from the rear side to the front side and has a lowest part adjacent to the front side.

### BRIEF DESCRIPTION OF THE DRAWINGS

The above and other features and advantages of the present invention will become apparent in the following detailed description of the preferred embodiment with reference to the accompanying drawings, in which:

FIG. 1 is a partly sectional view of a preferred embodiment of a liquid container of this invention;

FIG. 2 is a fragmentary perspective view of the preferred embodiment; and

FIG. 3 is another partly sectional view of the preferred embodiment viewed from a different angle.

### DETAILED DESCRIPTION OF THE PREFERRED EMBODIMENT

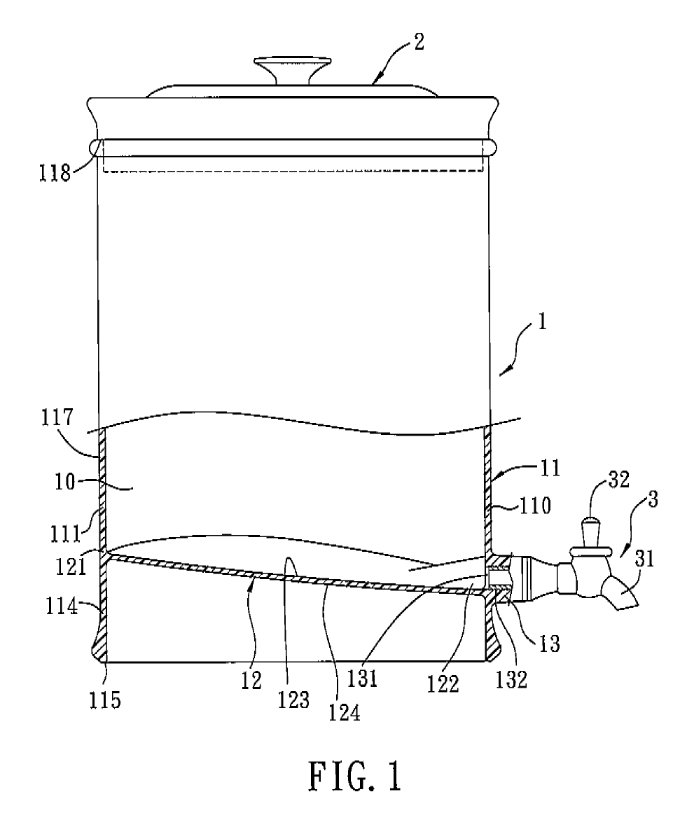

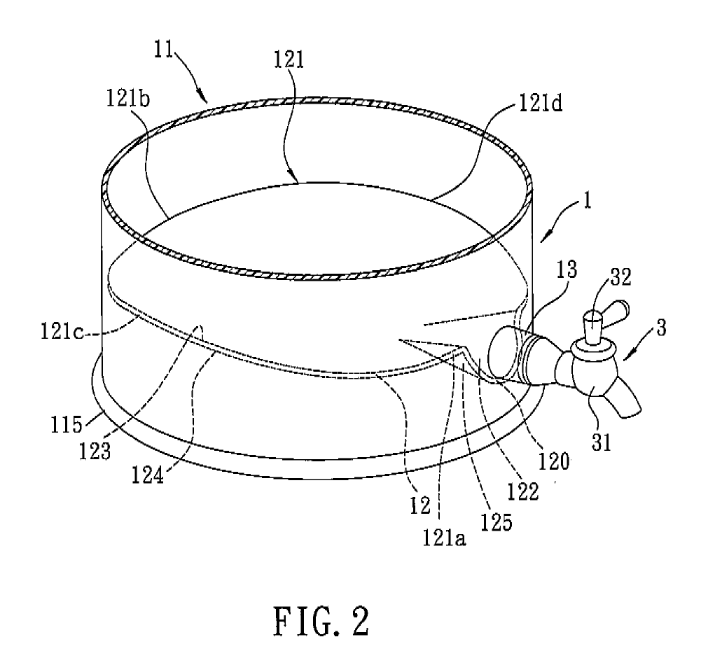

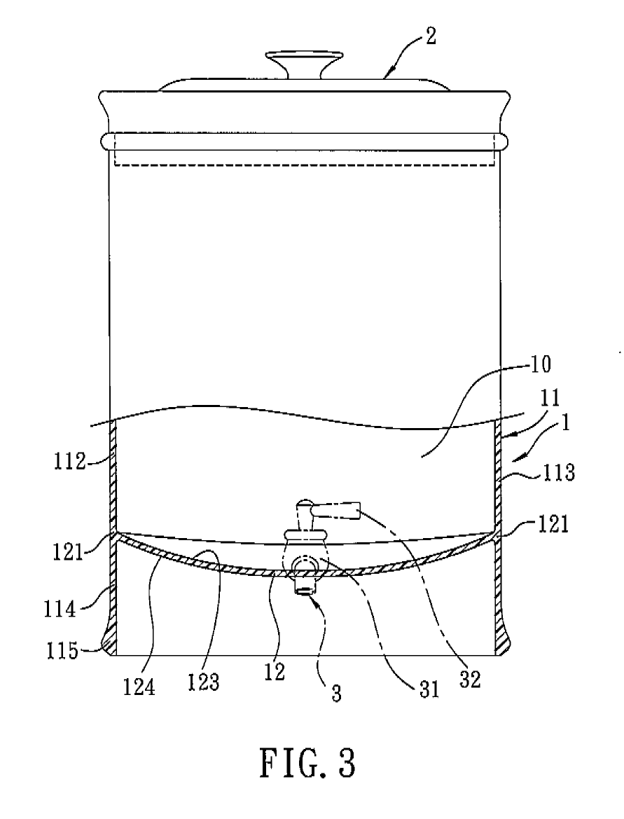

FIGS. 1, 2 and 3 show a preferred embodiment of a liquid container of this invention that comprises: a housing 1 including a bottom wall 12, an upright surrounding wall 11 that has a top portion 117 extending upwardly from a peripheral edge 121 of the bottom wall 12, and a receiving space 10 defined by the bottom wall 12 and the top portion 117 of the upright surrounding wall 11; a cap 2 removably attached to the top portion 117 of the upright surrounding wall 11 to cover the receiving space 10; and a tap 3 connected to the upright surrounding wall 11.

The upright surrounding wall 11 of the housing 1 has front, rear, left and right sides 110, 111, 112, 113. The front side 110 has a liquid outlet opening 131 communicated with the receiving space 10. The bottom wall 12 is inclined downwardly from the rear side 111 to the front side 110 and has a lowest part 122 adjacent to the front side 110, a top surface 123, and a bottom surface 124 interconnected by the peripheral edge 121. Preferably, the upright surrounding wall 11 has a bottom end portion 114 that extends downwardly from the peripheral edge 121 of the bottom wall 12. The top portion 117 has a first lip 118 formed at an open end of the top portion 117 opposite to the bottom wall 12. The bottom end portion 114 has a second lip 115 formed at an end of the bottom end portion 114 opposite to the bottom wall 12. The lowest part 122 of the bottom wall 12 has a trough 120 that is indented downwardly from the top surface 123 and that protrudes from the bottom surface 124. The trough 120 is communicated with the liquid outlet opening 131.

The liquid container of the present invention further includes a tubular body 13 projecting forwardly from the front side 110 of the upright surrounding wall 11 and extending around the liquid outlet opening 131, and the aforesaid tap 3 is attached to the tubular body 13. The tap 3 comprises a tap body 31 and a handle 32 connected to the tap body 31. The tap body 31 is formed with a liquid passage having an inlet that is fluidly connected to the tubular body 13. The tubular body 13 is disposed substantially at a same level as the trough 120 and has a tubular wall 132. The trough 120 further has a trough-defining wall 125 that is inclined downwardly and frontwardly. A lowest point of the tubular wall 132 is not higher than a lowest point of the trough-defining wall 125.

Preferably, the bottom wall 12 has a curved cross section along an upright plane that extends in a left-right direction and between the front and rear sides 110, 111. The peripheral edge 121 of the bottom wall 12 has front, rear, left and right edge portions 121a, 121b, 121c, 121d that are interconnected. The bottom wall 12 extends downwardly from the left and right edge portions 121c, 121d to a region between the left and right edge portions 121c, 121d. The left and right edge portions 121c, 121d are higher than the rear edge portion 121b, and the rear edge portion 121b is higher than the front edge portion 121a. Therefore, a liquid received in the receiving space 10 will physically flow toward the front edge portion 121a of the bottom wall 12.

The housing 1 and the tubular body 13 can be integrally made from a plastic material, a metal material, etc.

Consequently, according to the present invention, with the inclined and curved bottom wall 12 and the trough 120, the small amount of the liquid in the receiving space 10 of the liquid container will flow to the lowest part 122, and flow out of the liquid container through the trough 120, the tubular body 13, and the tap 3 without the need to tilt the liquid container.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A liquid container, comprising:
a housing that includes a bottom wall, an upright surrounding wall that has a top portion extending upwardly from a peripheral edge of said bottom wall, and a receiving space defined by said bottom wall and said top portion of said upright surrounding wall, said upright surrounding wall having front, rear, left and right sides, said front side having a liquid outlet opening communicated with said receiving space, said bottom wall being inclined downwardly from said rear side to said front side and having a lowest part adjacent to said front side.

2. The liquid container of claim 1, wherein said bottom wall has a top surface and a bottom surface interconnected by said peripheral edge, said lowest part having a trough that is indented downwardly from said top surface and that protrudes from said bottom surface, said trough being communicated with said liquid outlet opening.

3. The liquid container of claim 2, further comprising a tubular body projecting forwardly from said front side of said upright surrounding wall and extending around said liquid outlet opening, and a tap attached to said tubular body, said tubular body being disposed substantially at a same level as said tough.

4. The liquid container of claim 3, wherein said trough has a trough-defining wall that is inclined downwardly and frontwardly, said tubular body having a tubular wall, a lowest point of said tubular wall being not higher than a lowest point of said trough-defining wall.

5. The liquid container of claim 1, wherein said bottom wall has a curved cross section along an upright plane that extends in a left-right direction and between said front and rear sides.

6. The liquid container of claim 5, wherein said peripheral edge of said bottom wall has front, rear, left and right edge portions that are interconnected, said rear edge portion being higher than said front edge portion, said bottom wall extending downwardly from said left and right edge portions to a region between said left and right edge portions, said left and right edge portions being higher than said rear edge portion.

7. The liquid container of claim 1, wherein said upright surrounding wall has a bottom end portion that extends downwardly from said peripheral edge of said bottom wall.

8. The liquid container of claim 5, further comprising a cap removably attached to said top portion of said upright surrounding wall to cover said receiving space.
